(19) United States
(12) Patent Application Publication
(10) Pub. No.: US 2005/0137896 A1
(43) Pub. Date: Jun. 23, 2005

(54) Integrated recruiting system and method

(76) Inventors: Jared D. Pentecost, Fishers, IN (US); Joseph Milazzo, Indianapolis, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/743,193

(22) Filed: Dec. 22, 2003

(51) Int. Cl. G06F 17/60

(52) U.S. Cl. 705/1

(57) ABSTRACT

A computer system and method is disclosed that includes having video kiosks distributed across various locations that record and transmit videos to a central database for inclusion in a portfolio. The video kiosks include a computer with a touch-screen display and a camera, and can be full-size kiosks or mini-size kiosks depending on space and privacy considerations. A computer system and method is disclosed that includes providing authorized users with access to one or more portfolios, including video recordings received from a video kiosk. The video recordings can be a video resume or a video response to interview questions, as a few examples.

### BACKGROUND OF THE INVENTION

The present invention relates to computer systems, and more particularly, but not exclusively, relates to recruiting systems.

Various methods are used in facilitating the recruiting process and matching up candidates with prospective employers. Such methods have included allowing candidates to upload videos, such as video resumes, to give their profile a more personal flavor. However, due to the complexity, inconvenience and cost involved with the taping, editing and post-production of the video, the burden of generating the video is typically placed on the candidate's shoulders. If the candidate purchases or uses existing equipment such as a web camera to record the video, the quality is typically poor or unprofessional. If the candidate visits a recording studio, he has to obtain a digital version of the recording and then upload it to his profile on a career board. Such an approach is inconvenient, time consuming, and expensive. There is therefore a need for an easier system and method for allowing candidates to record higher quality videos and for employers to view these videos. The present invention is directed to meeting this and other needs.

### SUMMARY OF THE INVENTION

One form of the present invention is a recruiting system. Other forms include unique systems and methods to improve recording and capturing of video recordings in a candidate portfolio.

Another form includes operating a computer system that has video kiosks distributed across various locations that record and transmit videos to a video processing server for further processing and inclusion in a portfolio. The video kiosks include a computer with a touch-screen display and a camera, and can be fill-size kiosks or mini-size kiosks depending on space and privacy considerations. Another form includes operating a computer system that receives a video recording from a video kiosk, stores the video recording in a portfolio, and provides an authorized user with access to one or more portfolios. The video recordings can be a video resume or a video response to interview questions, as a few examples. Yet another form includes operating a computer system that provides authorized users with access to one or more candidate portfolios, including video recordings received from a video kiosk.

Further forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a view of a full-size video kiosk for the system of FIG. 1.

FIG. 3 is a perspective view of a full-size video kiosk for the system of FIG. 1.

FIG. 4 is a front view of a mini-size video kiosk for the system of FIG. 1.

FIG. 5 is a side view of a mini-size video kiosk for the system of FIG. 1.

FIG. 6 is a diagram for the system of FIG. 1 illustrating the elements stored in a candidate ePortfolio.

FIG. 7 is a process flow diagram for the system of FIG. 1 demonstrating the stages involved in creating a candidate ePortfolio.

FIG. 8a is a first half process flow diagram for the system of FIG. 1 demonstrating the stages involved in recording a video at a video kiosk.

FIG. 8b is a second half process flow diagram for the system of FIG. 1 demonstrating the stages involved in reviewing and saving a video recorded at a video kiosk.

FIG. 9 is a simulated screen for the system of FIG. 1 and process of FIG. 8 illustrating an introduction screen on a video kiosk.

FIG. 10 is a simulated screen for the system of FIG. 1 and process of FIG. 8 illustrating a log-in screen on a video kiosk.

FIG. 11 is a simulated screen for the system of FIG. 1 and process of FIG. 8 illustrating a welcome screen on a video kiosk.

FIG. 12 is a simulated screen for the system of FIG. 1 and process of FIG. 8 illustrating an instruction screen on a video kiosk.

FIG. 13 is a simulated screen for the system of FIG. 1 and process of FIG. 8 illustrating a camera positioning screen on a video kiosk.

FIG. 14 is a simulated screen for the system of FIG. 1 and process of FIG. 8 illustrating a still photo screen on a video kiosk.

FIG. 15 is a simulated screen for the system of FIG. 1 and process of FIG. 8 illustrating a begin video recording screen on a video kiosk.

FIG. 16 is a simulated screen for the system of FIG. 1 and process of FIG. 8 illustrating a stop video recording screen on a video kiosk.

FIG. 17 is a simulated screen for the system of FIG. 1 and process of FIG. 8 illustrating a screen for reviewing videos and selecting a video from a video kiosk.

FIG. 18 is a simulated screen for the system of FIG. 1 and process of FIG. 8 illustrating a screen for confirming a video selection from a video kiosk.

FIG. 19 is a simulated screen for the system of FIG. 1 and process of FIG. 8 illustrating a screen for verifying the selected video was accepted.

### DETAILED DESCRIPTION OF SELECTED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

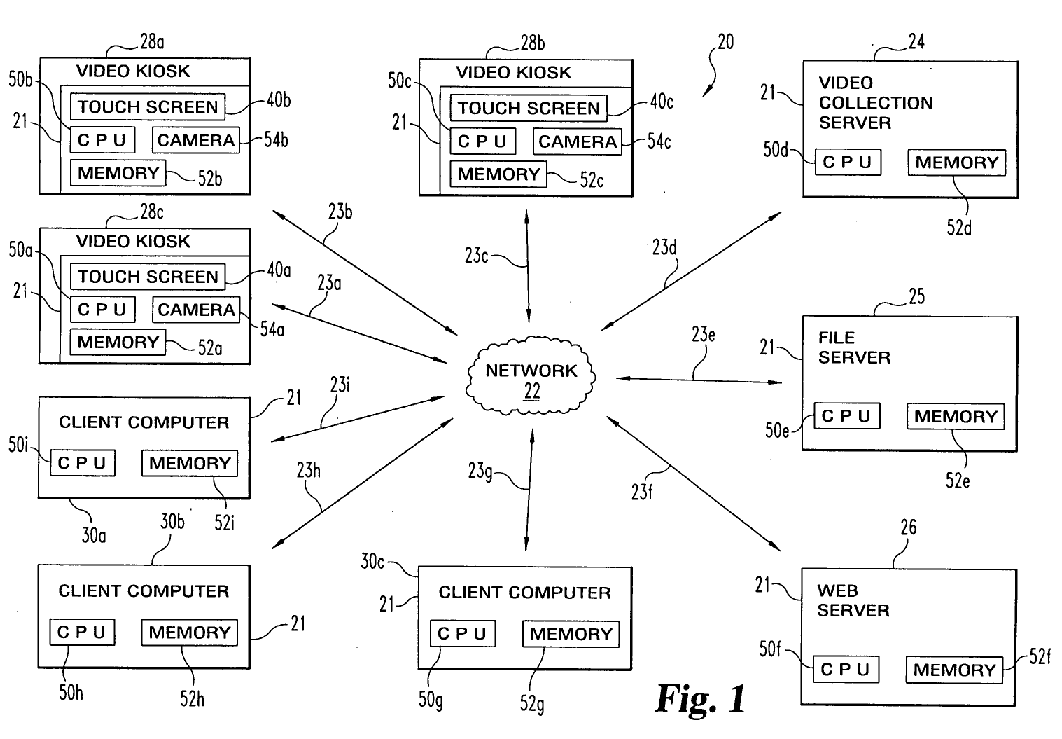

One embodiment of the present invention includes a unique recruiting system. FIG. 1 is a diagrammatic view of computer system 20 of one embodiment of the present invention. Computer system 20 includes computer network 22. Computer network 22 couples together a number of computers 21 over network pathways 23. More specifically, system 20 includes several servers, namely Video Collection Server 24, File Server 25, and Web Server 26. System 20 also includes Video Kiosks 28a, 28b, and 28c, and Client Computers 30a, 30b, and 30c. While computers 21 are illustrated as being a client or a server, it should be understood that any of computers 21 may be arranged to include both a client and server, just a client, or just a server. Furthermore, it should be understood that while nine computers 21 are illustrated, more or fewer may be utilized in alternative embodiments.

Computers 21 include one or more processors or CPUs (50a, 50b, 50c, 50d, 50e, 50f, 50g, 50h, and 50i, respectively) and one or more types of memory (52a, 52b, 52c, 52d, 52e, 52f, 52g, 52h and 52i, respectively). Each memory 52a, 52b, 52c, 52d, 52e, 52f, 52g, 52h and 52i includes a removable memory device, which is not shown to preserve clarity. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or otherwise) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD); a magnetically encoded hard disc, floppy disc, tape, or cartridge media; or a combination of any of these memory types. Also, each memory may be volatile, nonvolatile, or a hybrid combination of volatile and nonvolatile varieties.

Each video kiosk includes a video camera 54a, 54b, and 54c or other such video recording unit coupled to the computer and used for recording videos. Various types of video cameras can be used and can be connected to computer in various ways, such as through a USB or other port on CPU (50a, 50b, or 50c), to name one non-limiting example. In one embodiment, the video camera is a video recording unit that is capable of capturing professional-quality video capture.

In one embodiment, each video kiosk computer includes a Touch Screen display 40a, 40b, and 40c for an input means. Alternatively or additionally, the input means can be one or more combinations of a mouse, keyboard, touch pad, and/or voice command microphone or other such input device(s) as would occur to one of ordinary skill in the art.

Computer network 22 can be in the form of a Local Area Network (LAN), Municipal Area Network (MAN), Wide Area Network (WAN), such as the Internet, a combination of these, or such other network arrangement as would occur to those skilled in the art. The network can be wired, wireless, satellite, a combination of these, or be other arrangements as known in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates as a recruiting system at one or more physical locations with Video Collection Server 24 being configured as a server for receiving and processing videos that were recorded at one of Video Kiosks (28a, 28b, or 28c), File Server 25 being configured as a server for storing the video recordings and associated candidate data, and Web Server 26 being configured as a server to allow users to access candidate and employer records, including stored video recordings, from one of Client Computers (30a, 30b, or 30c). It should be understood by one in the computer software art that various other server arrangements are possible, such as one or more servers acting as both a Video Collection Server and a Web Server, one or more servers acting as both a File Server and a Web Server, or one or more servers acting as all three, to name a few non-limiting examples. Typically applications of system 20 would include many more Client Computers 30a, 30b, and 30c and many more Video Kiosks 28a, 28b, and 28c, at one or more physical locations, but only a few have been illustrated in FIG. 1 to preserve clarity.

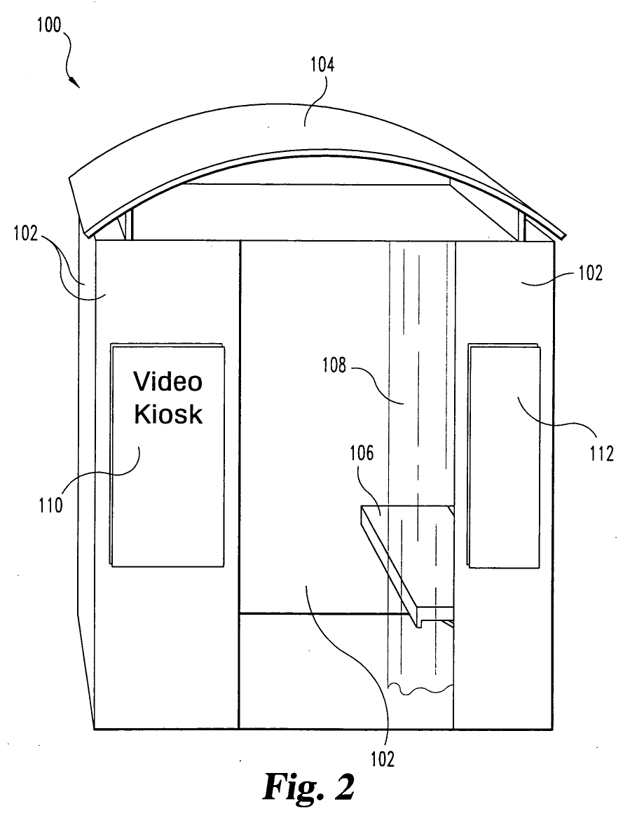

Video Kiosks 28a, 28b, and 28c can be full-size or mini-size kiosks, located at various physical locations such as in retail stores or other facilities. In one embodiment, full-size kiosks are used to provide a full enclosure for areas in a public space that need privacy while mini-size kiosks are used for private and educational partners where the kiosk can be placed in a more controlled private setting. As will be described hereafter, FIGS. 2-5 illustrate full-size and mini-size kiosks in further detail. Referring now to FIG. 2, a full-size kiosk 100 is illustrated. Full-size kiosk 100 includes multiple walls 102 for providing a privacy enclosure, a bench 106 for allowing a user to sit down, and a curtain 108 or other means such as a door on one of the walls 102 that allows entry and exit from the kiosk and ensures aids privacy. Full-size kiosk 100 can optionally include a roof 104, a sign 110 to indicate its purpose, and/or or a bulletin board 112 for posting announcements.

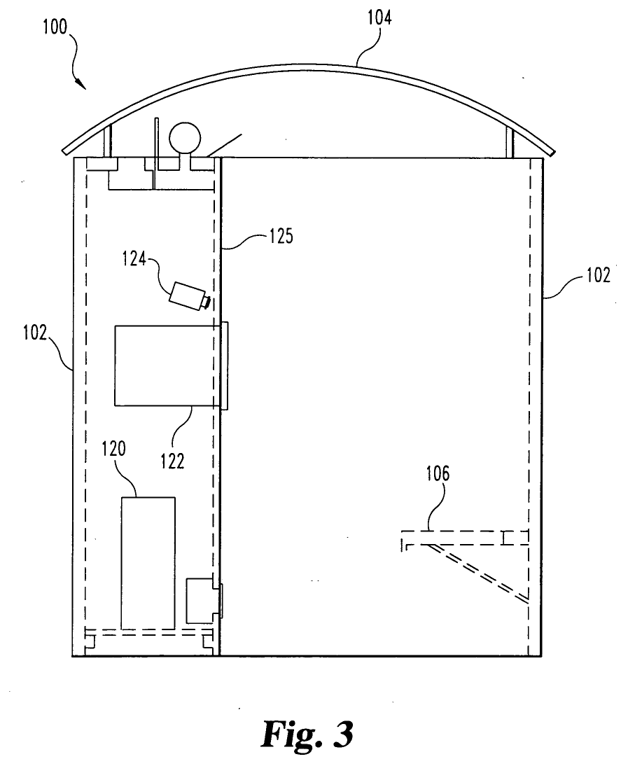

Referring additionally to FIG. 3, a perspective view of full-size kiosk 100 is shown. A video camera 124 and a computer including a central processing unit 120 and a display 122 are located in a housing unit which consists of an inner wall 125 and a portion of the outer walls 102. Alternatively or additionally, computer can include internal or external speakers to allow a user to hear sounds that are output by computer. Bench 106 allows a candidate to sit in front of video camera 124 and display 122. In one embodiment, the distance between bench 106 and inner wall 125 allows a user to reach the display 122 while sitting down. Although not shown to preserve clarity, one of ordinary skill in the art will appreciate that other components can be present inside the full-size kiosk, such as cables connecting the components together, one or more power cords and/or outlets, network cables and/or outlets, to name a few non-limiting examples.

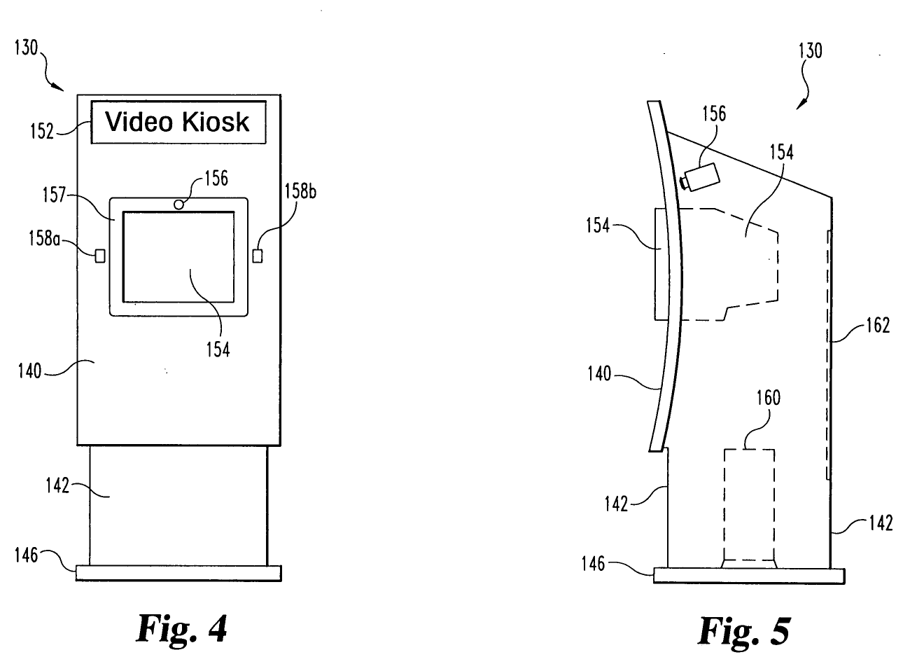

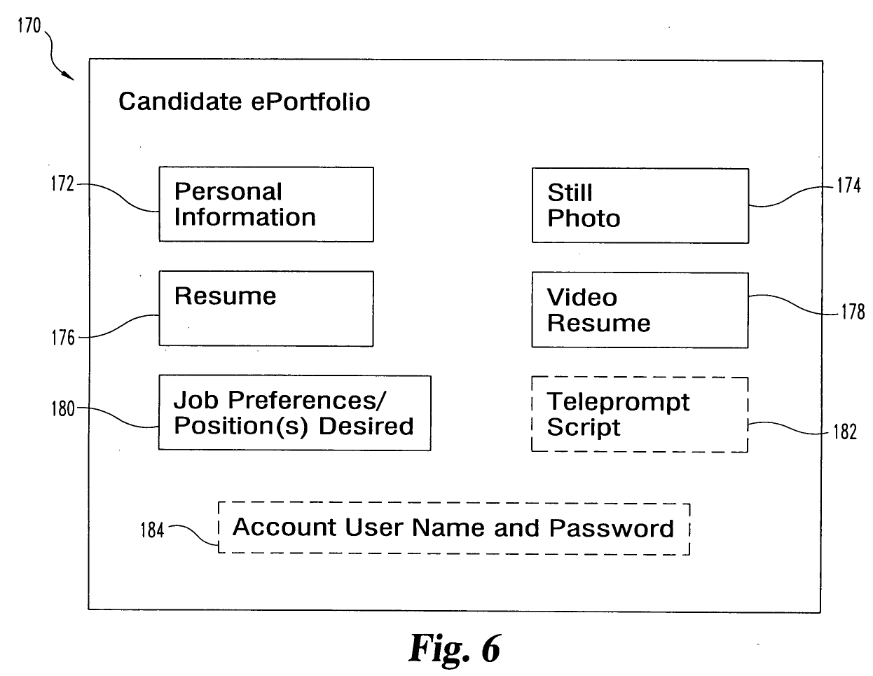

An example of a mini-size kiosk is shown in FIGS. 4 and 5. As shown in FIG. 4, mini-size kiosk 130 is housed in an upright unit that includes an upper member 140, a base member 142, and a floor member 146. Mini-size kiosk 130 reveals a video camera 156 and display 154 in a viewing area 157. Alternatively or additionally, mini-size kiosk can include external speakers 158a and 158b coupled to computer 160, or speakers that are internal to computer. A sign 152 can be used to display a message indicating the purpose of the system or other desired message.

As shown in FIG. 5, the upper member 140 can be curved if desired for aesthetic appeal or other reasons. A door or access panel 162 is provided on one side of mini-kiosk 130 to allow for access to the contents. Mini-size kiosk 130 contains a video camera 156 and a computer including a central processing unit 160 and a display 154. In one embodiment, a chair or bench is positioned in front of base member 142 to allow a user to sit down while accessing display 154 and/or recording a video. In another embodiment, a user accesses the display and/or records a video while standing. Although not shown to preserve clarity, one of ordinary skill in the art will appreciate that other components can be present inside the mini-size kiosk, such as cables connecting the components together, one or more power cords and/or outlets, network cables and/or outlets, to name a few non-limiting examples.

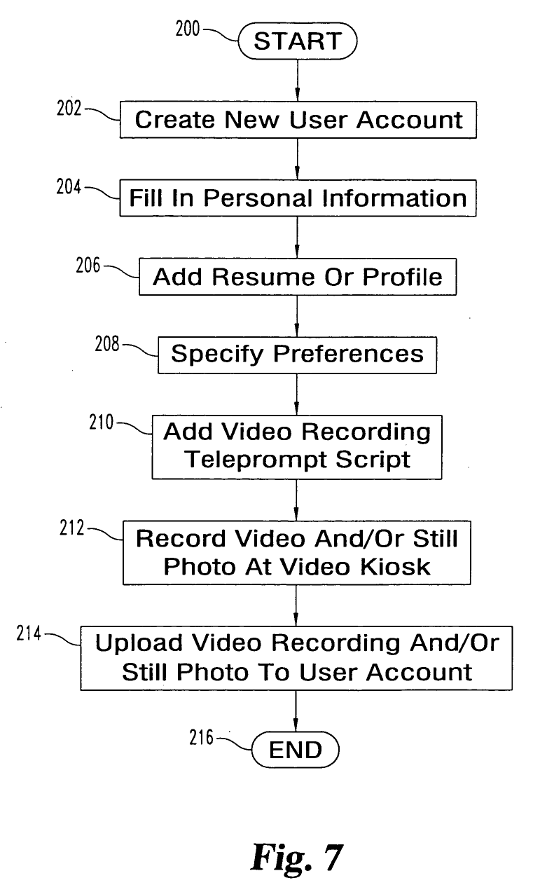

Referring now to FIG. 6 with continued reference to FIG. 1, the contents of a candidate ePortfolio 170 in one embodiment are displayed. In one aspect of the invention, system 20 is used as a recruiting system that allows a candidate to generate an ePortfolio 170 and potential employers to access one or more candidate ePortfolios 170 to find a match for an open position. A candidate eportfolio 170 can include both private and public information. For example, personal information 172, a still photo of the candidate 174, a resume 176, a video resume 178, and job preferences/position(s) desired 180 included in ePortfolio 170 might be accessible by the candidate and potential employers, while a teleprompt script 182 and account credentials (user name and password) 184 might only be accessible by the candidate.

In one embodiment, video resume 178 of candidate ePortfolio 170 can be captured at one of the video kiosks 28a, 28b, or 28c and transmitted to Video Collection Server 24 for further processing and later storage on File Server 25 with the rest of candidate ePortfolio 170. Candidate ePortfolios 170 can be accessed from Web Server 26 when requested by an authorized user from client computer 30a, 30b, or 30c. As one non-limiting example, users such as a prospective employer can run searches to find all candidate ePortfolios that meet a specified criteria. The search can be performed interactively, or can be set up as criteria that is saved and then the results displayed when selecting a particular retrieve option in system 20. From the list of results, users can select a candidate ePortfolio and view the related details, including the video resume and/or still photo that was recorded at a video kiosk. In one embodiment, an employer can specify search criteria for one or more open positions and then receives messages in a virtual inbox that link to each candidate eportfolio that met the specified criteria.

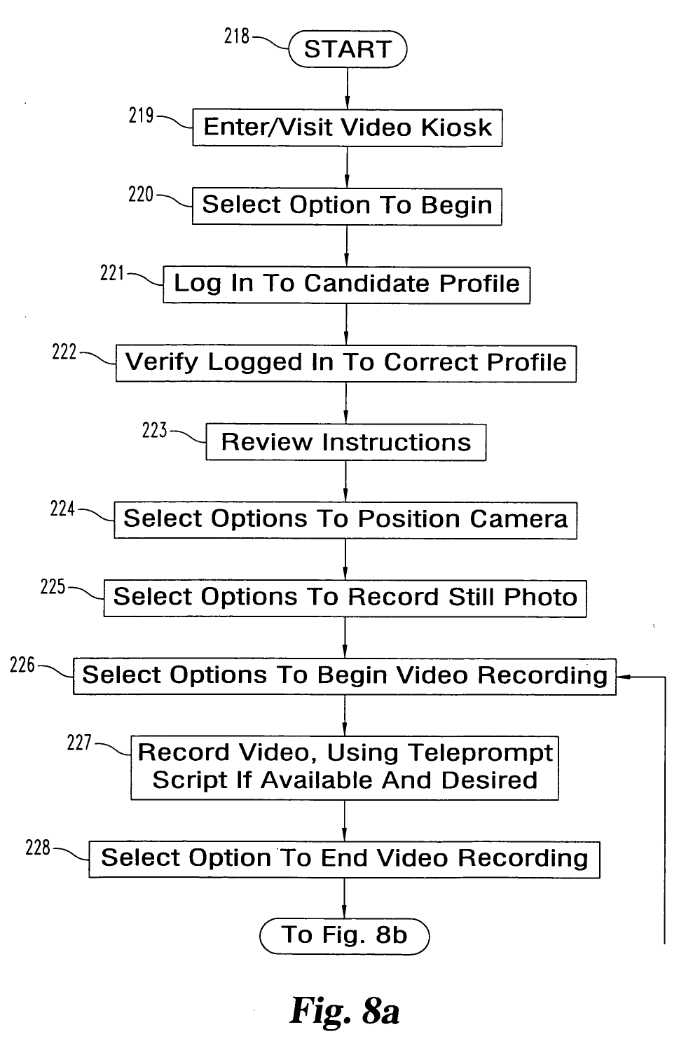

Referring to FIG. 7 with continued reference to FIG. 1, one embodiment for implementation with system 20 is illustrated in flow chart form as procedure 200, which demonstrates a high level process for generating a candidate ePortfolio. In one form, procedure 200 is at least partially implemented in the operating logic of system 20. Procedure 200 begins with a user creating a new user account (stage 202). User then fills in personal information (stage 204), such as name and address, and can add various other pieces of information to indicate his/her qualifications and/or preferences. For example, user can add a resume or profile (stage 206), specify the job position(s) desired (stage 208), and/or input a video recording teleprompt script (stage 210) that can later be used to aid in recording a video resume from a video kiosk. After filling in at least the minimum amount of information required for generating a new candidate profile, the user visits a video kiosk 28a, 28b, or 28c and records a video and/or still photo (stage 212) to be included in the ePortfolio. The recorded video and/or still photo is transmitted over network 22 from the video kiosk to Video Collection Server 24 for further processing, and is ultimately stored on File Server 25 in the candidate's ePortfolio (stage 214). Authorized users such as the candidate or a prospective employer can access the ePortfolio before or after a video recording is recorded and stored, as described in further detail herein.

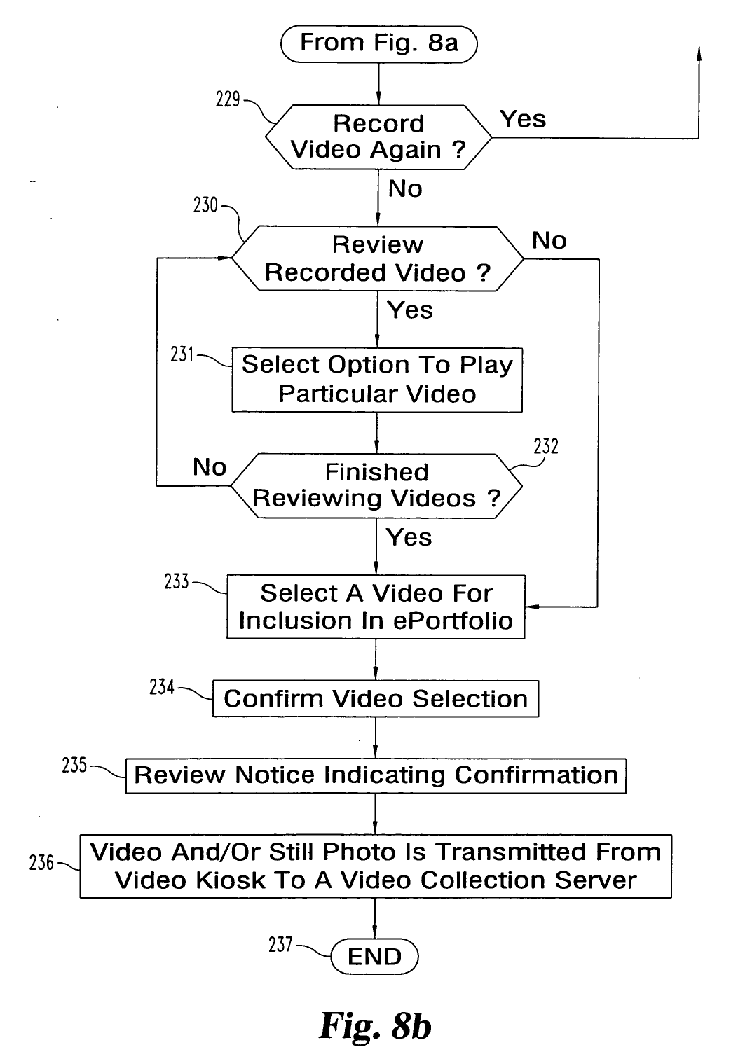

With this understanding, reference is now made to FIGS. 8a and 8b. In FIG. 8, another embodiment for implementation with system 20 is illustrated in flow chart form as procedure 218 for recording a video and/or still photo at a video kiosk. In one form, procedure 218 is at least partially implemented in the operating logic of system 20. Procedure 218 begins on FIG. 8a with a user visiting or entering a video kiosk (stage 219). The user selects an option to begin (stage 220), and logs in to his candidate profile (stage 221). In one embodiment, user logs into a candidate profile that was created prior to visiting the video kiosk. In another embodiment, a new candidate profile is established at the video kiosk. After verifying that he is logged in to the correct profile (stage 222), the user reviews instructions (stage 223) for recording a video and/or still photo. The user selects one or more options to position the camera as desired (stage 224). The user can select an option to record a still photo (stage 225). When ready to record a video, the user selects an option to begin video recording (stage 226). The user then speaks into the video camera, and uses a teleprompt script to assist with the recording if a teleprompt script exists for the user's profile and the user desires to use the script for assistance (stage 227). When the user is finished recording the video, he selects an option to end the video recording (stage 228).

Now continuing with FIG. 8b, the user can be given an option to record another video (decision point 229), and if the user desires to record another video, the process returns to stage 226 where the user can select an option to begin recording. The user is given an option to review the recorded video(s) (decision point 230) and can select an option to play a particular recorded video (stage 231). If the user does not wish to review any recorded video (decision point 230) or if the user is finished reviewing recorded videos (decision point 232), then the user selects a video that he wants to have included in his ePortfolio (stage 233). After confirming a video selection (stage 234), the user receives and reviews a notice confirming his selection (stage 235). The video and/or still photo is transmitted from video kiosk 28a, 28b, or 28c to video collection server 24 (stage 236) for further processing. Further processing can include processing, encoding, indexing, and/or preparing the video for eventual on-demand streaming, to name a few non-limiting examples.

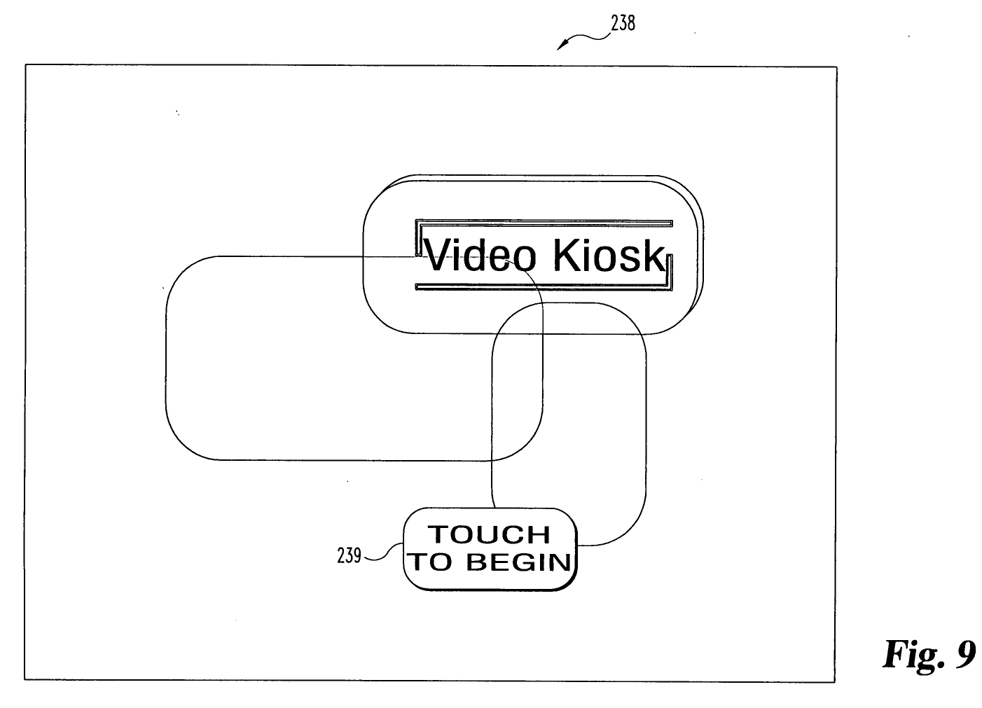

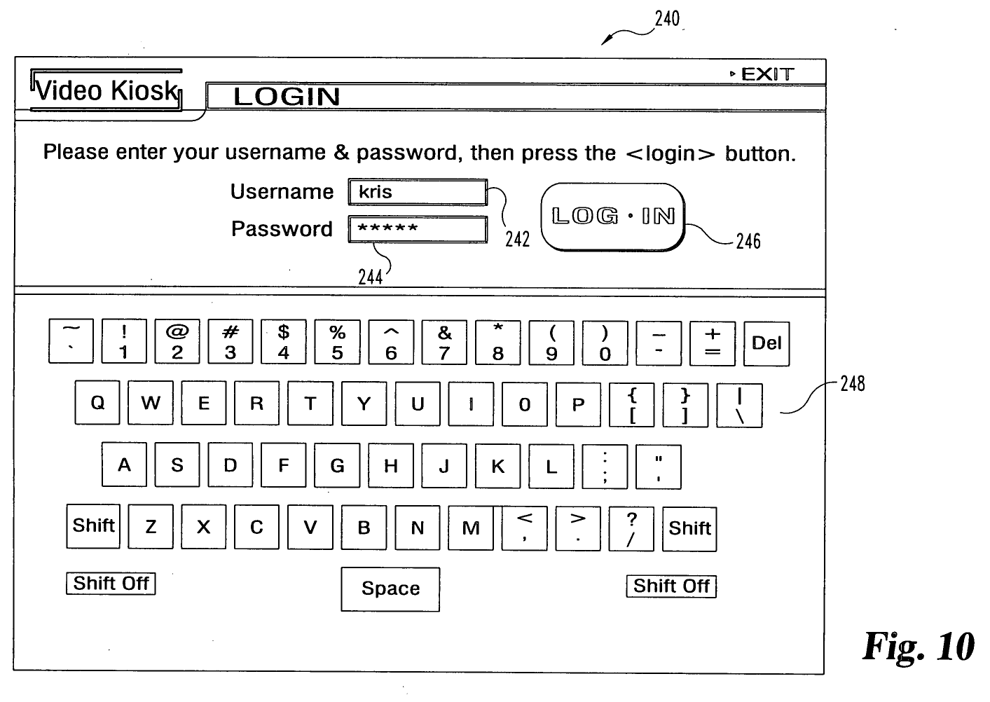

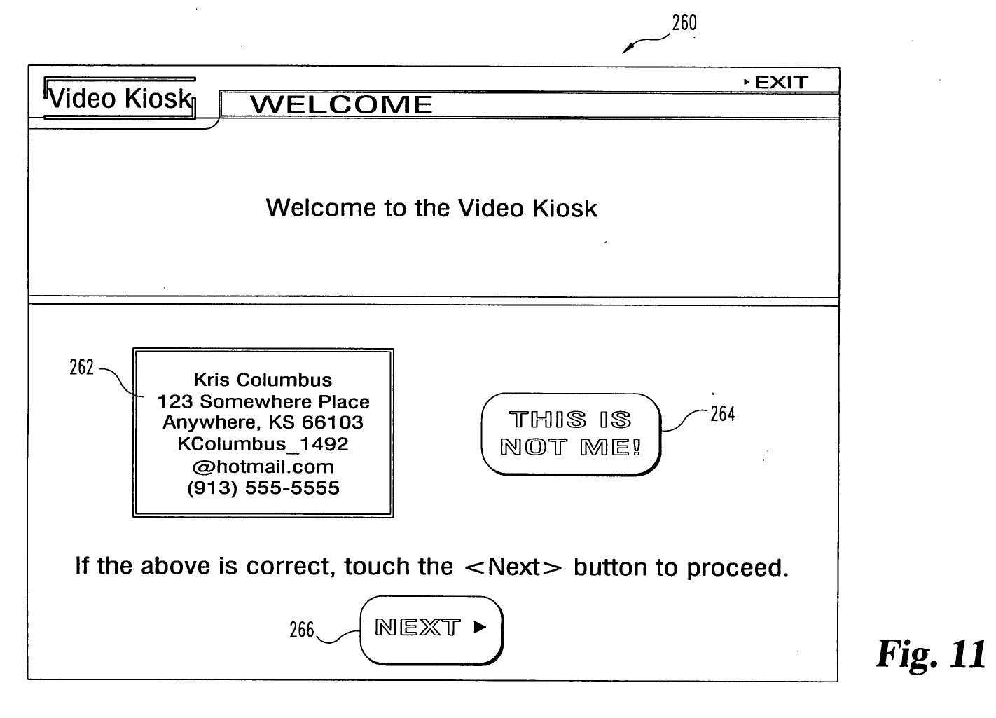

The steps outlined in FIGS. 8a and 8b will now be further illustrated by referring to FIGS. 9-19, which are simulated screens of the video kiosk display. This example illustrates how a female user named Kris Columbus uses the video kiosk to record a still photo and a video resume. Kris Columbus has already established her user profile before visiting the kiosk, and has already included personal information in her profile as well as a teleprompt script. As shown in FIG. 9, after the user enters or visits a video kiosk (stage 219), she selects an option to begin 239 (stage 220) from an introduction screen 238. A screen 240 as shown in FIG. 10 is then displayed. The user uses on-screen keyboard 248 to input a username 242 and password 244, and then selects an option to log in 246 to her profile (stage 221). A welcome screen 260 as shown in FIG. 11 is then displayed. Information about the profile is displayed 262 to allow the user to verify she is logged in to the correct profile (stage 222). If the incorrect profile is displayed, the user can select an option 264 to indicate the profile is not hers. If the profile is correct, which in this example it is, then she selects the option 266 to proceed to the next screen.

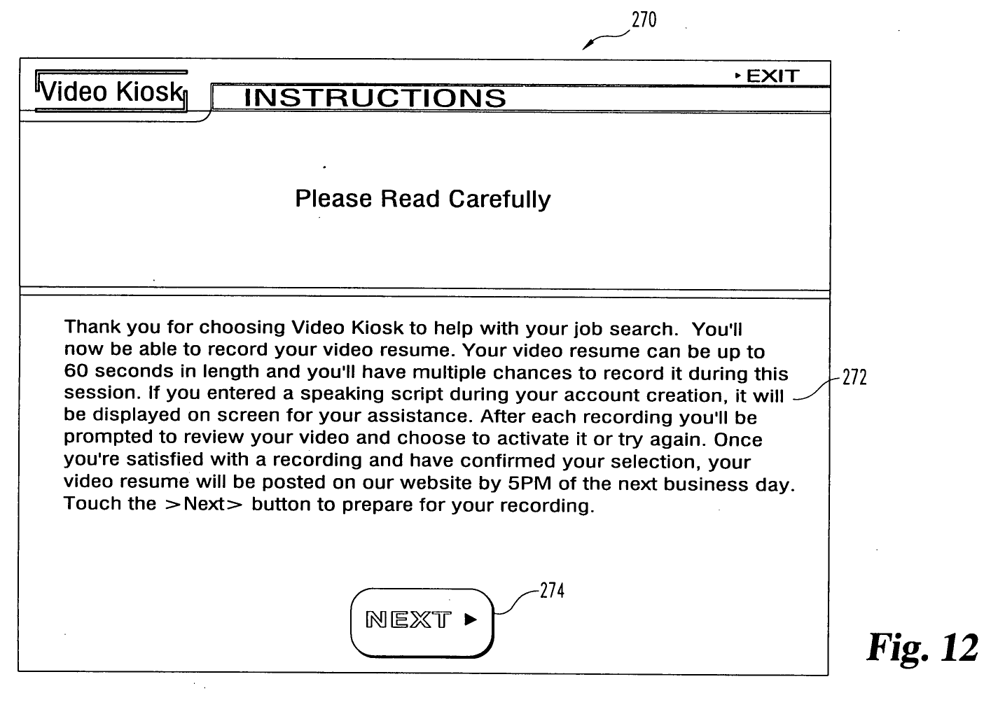

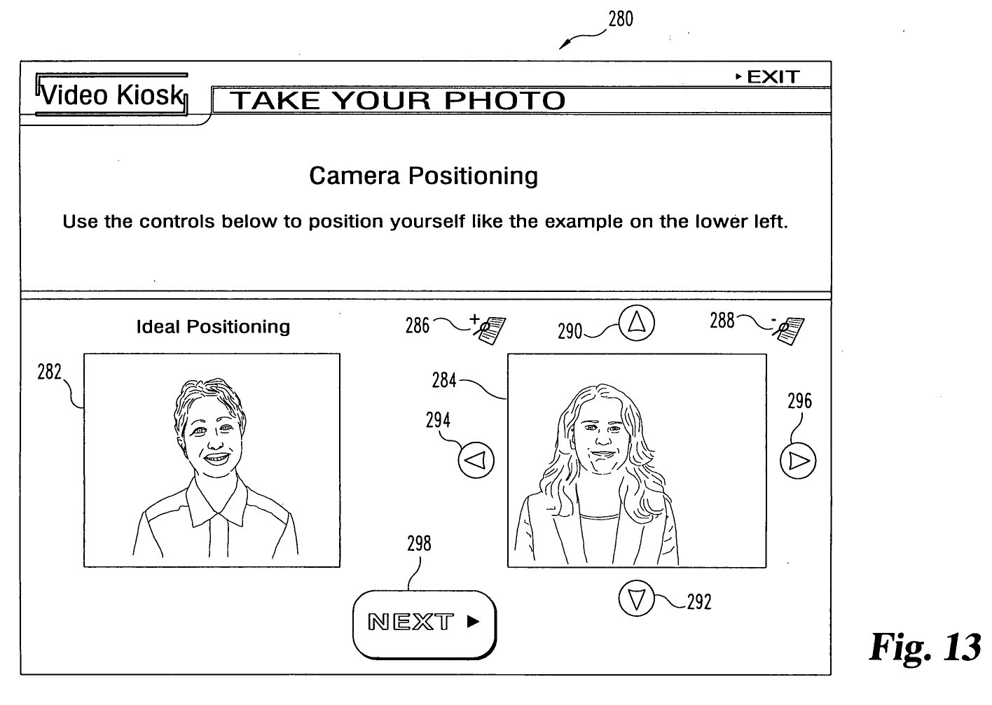

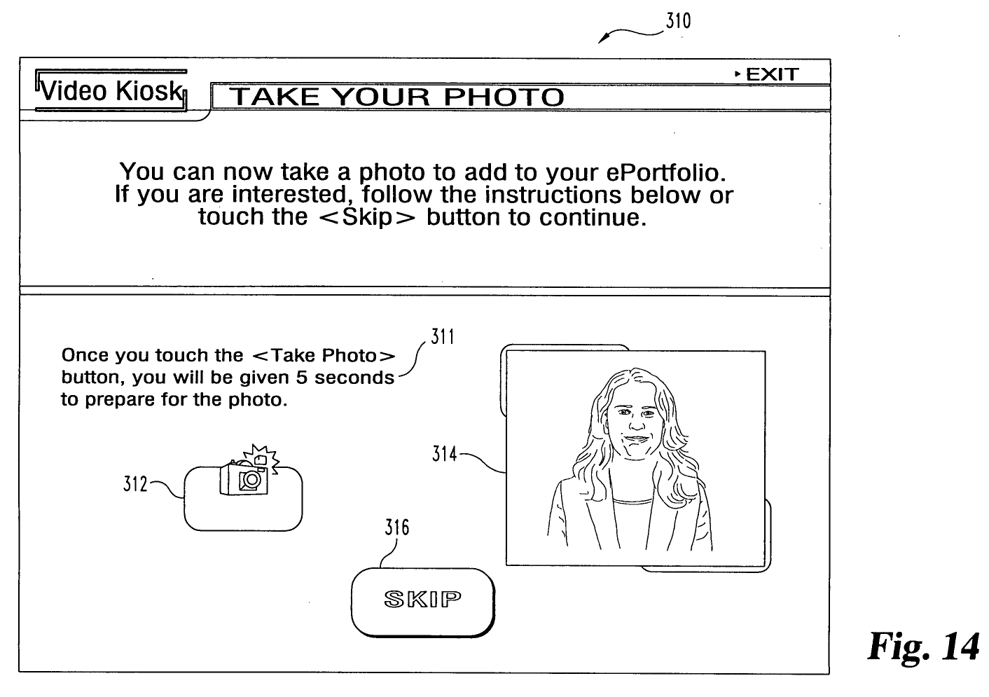

A screen 270 as shown on FIG. 12 is then displayed, providing the user with general instructions 272 for using the video kiosk (stage 223). The user can proceed to the screen shown on FIG. 13 by selecting the next option 274. A camera positioning screen 280 is then displayed, allowing the user to see an example of an ideal positioning 282 and to use various controls to adjust the camera position. The user selects zoom-in 286, zoom-out 288, up 290, down 292, left 294, and/or right 296 to position the camera to a desired location (stage 224). After positioning the camera as desired, the user selects the next option 298 to proceed to the screen shown in FIG. 14. The user reviews instructions 311, and, if desired, the user can take a photo to add to her eportfolio. If the user desires to have her photo taken, she selects a photo capture option 312 (stage 225) when ready. If the user does not wish to take a photo, she can select the skip option 316.

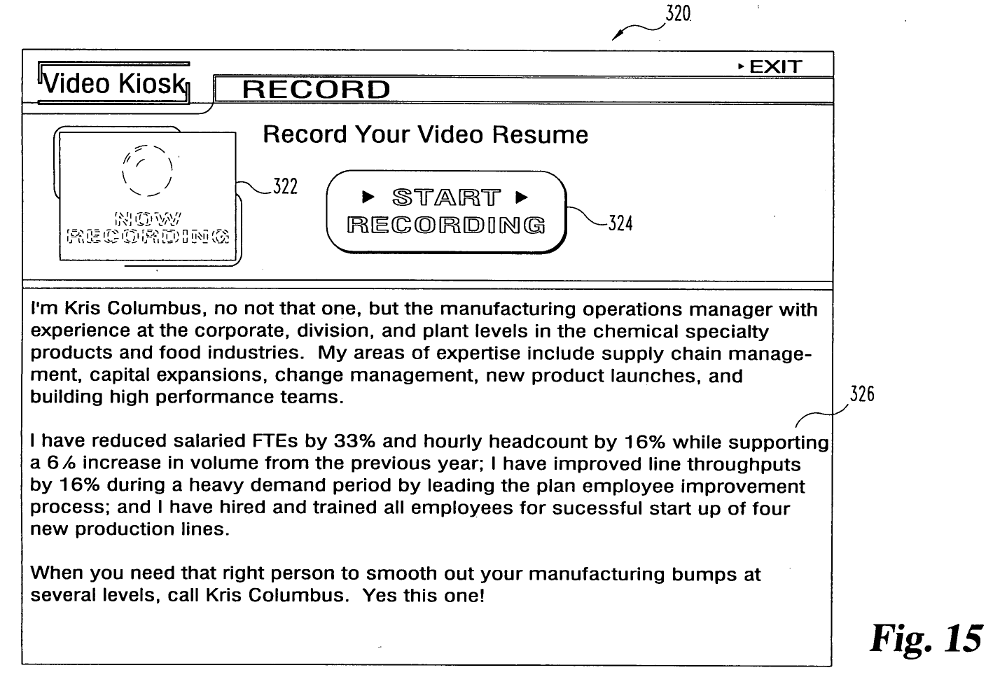

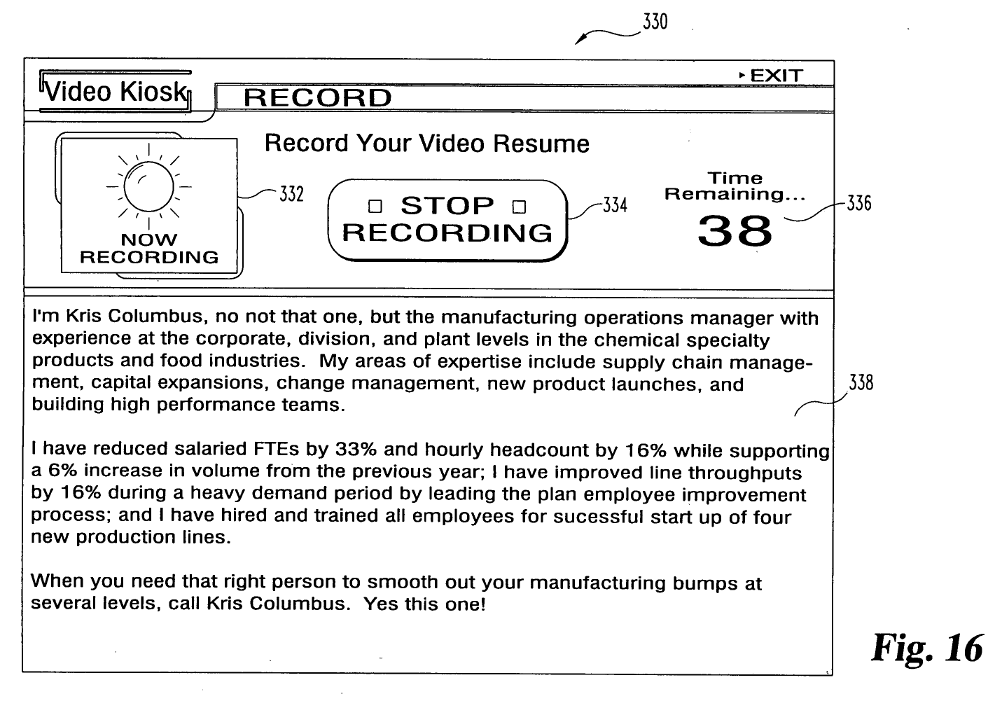

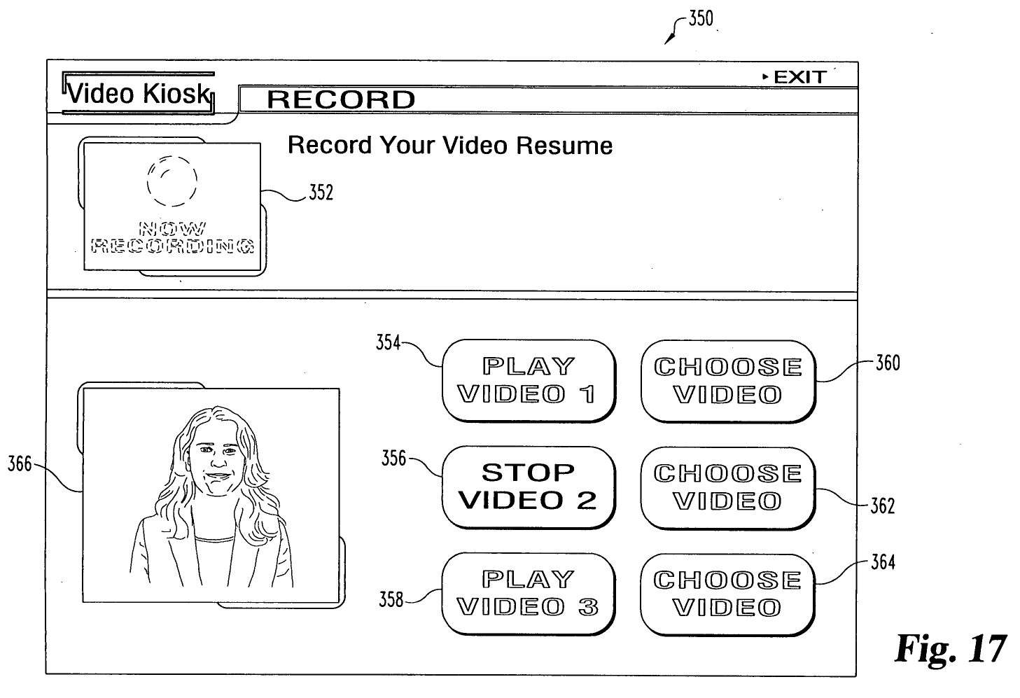

After taking the photo or skipping the photo, a screen 320 as shown in FIG. 15 is then displayed. A recording status indicator 322 indicates whether a video recording is in progress. At the bottom of the screen, a teleprompt script 326 from the user's profile is displayed. When ready to start the recording, the user selects the start recording option 324 (stage 226). A screen 330 as shown in FIG. 16 is then displayed. The recording status indicator 332 now indicates that the video camera of the video kiosk is recording. The user speaks into the camera, reading her teleprompt script 338 as desired (stage 227). A count-down timer 336 is displayed to indicate the amount of time remaining, if such a time-limit is placed on the user. When the user is finished recording her video, she selects the stop recording option 334 (stage 228). The user can select an option to record multiple videos (decision point 229), and if so, the process illustrated in FIG. 15-16 is repeated. The user can review a recorded video (decision point 230) by selecting an option to play a particular video (stage 231). As shown on the screen 350 in FIG. 17, the user has selected an option to play video 2 that she previously recorded. By selecting a stop option 356, the currently playing video 2 will stop. The other videos can also be played by selecting option 354 or 358. When the user is finished reviewing videos (decision point 232) and is ready to select a video to be included in her ePortfolio, she selects the respective choose video option 360, 362, or 364 that corresponds to her desired video choice (stage 233).

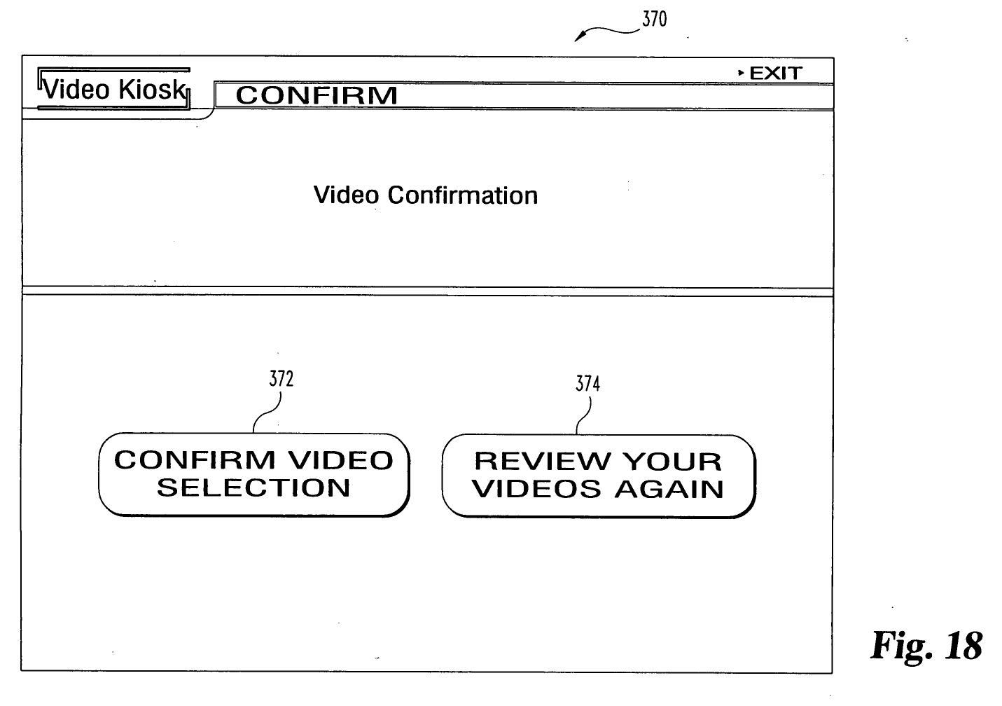

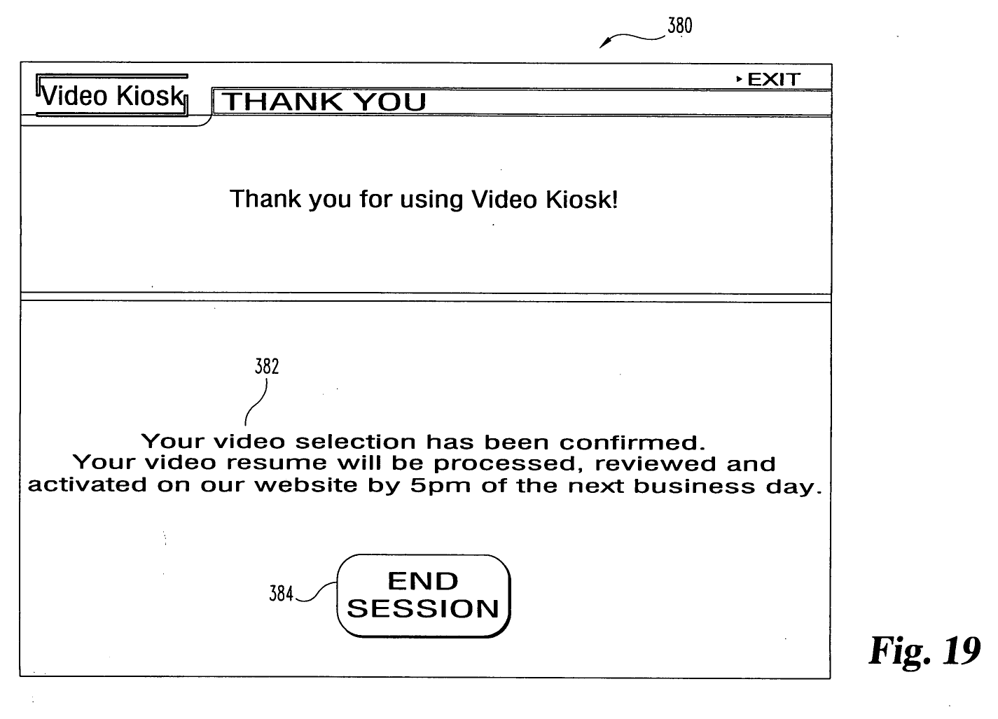

A screen 370 as shown in FIG. 18 is then displayed, allowing the user to select an option to confirm her video selection 372 (stage 234) or review her videos again 374. Once a video selection is confirmed (stage 234), a screen 380 as shown in FIG. 19 is then displayed. The user reviews completion notice 382 to confirm that the selected video will be included in the ePortfolio (stage 236). The recording session is ended by selecting an end session option 384.

Alternatively or additionally, the present invention can include various features allowing candidates to search open positions of employers and to communicate with employers when finding a position of interest. The present invention can also be used to assist prospective students who are candidates applying to a college or institution of learning, candidates applying for a leadership program, or various other situations involving matching a party seeking to apply for a position with a party seeking to fill the position, to name a few non-limiting examples. Alternatively or additionally, an employer can use the video kiosk to record a company profile, a set of interview questions, a job description, or a set of ideal or required qualifications. These employer recordings can be associated with a company portfolio or job position portfolio to be later reviewed by candidates seeking a job and/or presented to candidates as part of an interview process. Alternatively or additionally, the system can be used with in-house employment search situations, such as to fill an open position with existing employees of the company.

Alternatively or additionally, the present invention can be used to allow interview questions to be presented to a user and to allow a user to record a response at the video kiosk. Interview questions could be presented on the kiosk screen in a text format, could be read to the user by a text-to-speech processor, or could be presented by a virtual interviewer, to name a few non-limiting examples. The virtual interviewer could also have artificial intelligence capability and process candidate responses to determine the next logical question based on a decision tree. Alternatively or additionally, candidates could choose a virtual interviewer from a variety of virtual interviewer options.

Alternatively or additionally, the present invention can be used for various other purposes, such as to create and/or access individual or group video greeting cards, video profiles of persons seeking dates through a dating service, and/or video auditions for talent searches, as a few non-limiting examples. Various other applications are possible, as will be understood by one of ordinary skill in the art.

In one embodiment, a system is disclosed that comprises: a plurality of video kiosks distributed across multiple locations; and wherein said video kiosks are operative to record a plurality of videos and transmit the recorded videos over a network to a video collection server so each of the recorded videos can be associated with a corresponding portfolio in a database containing a plurality of portfolios.

In another embodiment, a method is disclosed that comprises: receiving a video recording of a person that was recorded at one of a plurality of video kiosk locations and transmitted from the video kiosk location over a network; storing the video recording in a portfolio associated with the person; and providing an authorized user with access to the portfolio.

In yet another embodiment, a method is disclosed that comprises: visiting a video kiosk at one of a plurality of video kiosk locations; entering identifying information to access a profile; selecting a begin recording option to begin recording a video with a camera; speaking a message into the camera; and selecting a stop recording option to stop recording the video with the camera.

In another embodiment, a system is disclosed that comprises: a video kiosk having a storage unit that houses a video camera coupled to a computer, said computer including a central processing unit, a display, an input means, and a connection to a network; and wherein said video kiosk is operative to record a video of a user and transmit the recorded video over the network to a video collection server so the recorded video can be associated with a corresponding portfolio in a database containing a plurality of portfolios.

One of ordinary skill in the computer software art will appreciate that the functionality, components and/or screens described herein can be separated or combined on one or more computers or screens in various arrangements and still be within the spirit of the invention. While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A system comprising:
a plurality of video kiosks distributed across multiple locations; and
wherein said video kiosks are operative to record a plurality of videos and transmit the recorded videos over a network to a video collection server so each of the recorded videos can be associated with a corresponding portfolio in a database containing a plurality of portfolios.

2. The system of claim 1, further comprising:
a web server operative to allow an authorized user to access one or more of the portfolios.

3. The system of claim 2, wherein the web server is further operative to allow the authorized user to search the portfolios for a specified criteria and to access one or more of the portfolios that met the specified criteria.

4. The system of claim 2, wherein the authorized user is an employer seeking to fill an open position.

5. The system of claim 1, wherein at least one of the recorded videos is a video resume.

6. The system of claim 1, wherein at least one of the recorded videos is a video interview, said video interview including responses to one or more questions presented.

7. The system of claim 1, wherein the video kiosks each have a video camera coupled to a computer, said computer including a central processing unit, a display, and an input means.

8. The system of claim 7, wherein the input means is a touch-screen on the display.

9. The system of claim 7, wherein at least one of the video kiosks comprises:
a free-standing storage unit that houses the camera and the computer.

10. The system of claim 7, wherein at least one of the video kiosks comprises:
a storage unit that houses the camera and the computer;
a bench;
a plurality of walls surrounding the bench and the storage unit; and
a door on one of the walls.

11. The system of claim 10, wherein the door allows entry and exit into the full-size kiosk when opened and privacy in the full-size kiosk when closed.

12. The system of claim 10, wherein the door is a curtain.

13. A method comprising:
receiving a video recording of a person that was recorded at one of a plurality of video kiosk locations and transmitted from the video kiosk location over a network;
storing the video recording in a portfolio associated with the person; and
providing an authorized user with access to the portfolio.

14. The method of claim 13, wherein the person is a job seeker.

15. The method of claim 13, wherein the person is an individual applying for college.

16. The method of claim 13, wherein the authorized user is an employer seeking to fill an open position.

17. The method of claim 13, wherein the authorized user is the person.

18. The method of claim 13, wherein said receiving and said storing are performed for a plurality of portfolios and wherein said providing includes searching the plurality of portfolios for a specified criteria and allowing the authorized user to view one or more portfolios that met the specified criteria.

19. The method of claim 13, wherein the recorded video is a video resume.

20. The method of claim 13, wherein the recorded video is a video interview, said video interview including responses to one or more questions presented to the person at the video kiosk location.

21. A method comprising:
visiting a video kiosk at one of a plurality of video kiosk locations;
entering identifying information to access a profile;
selecting a begin recording option to begin recording a video with a camera;
speaking a message into the camera; and
selecting a stop recording option to stop recording the video with the camera.

22. The method of claim 21, wherein prior to visiting the video kiosk, the profile is created.

23. The method of claim 21, wherein said entering identifying information to access a profile includes creating a new profile and then accessing the new profile.

24. The method of claim 21, wherein said entering identifying information, said selecting the begin recording option, and said selecting the stop recording option are performed by touching a display of the video kiosk.

25. The method of claim 21, further comprising:
prior to selecting the begin recording option, selecting at least one positioning option to position the camera to a desired position.

26. The method of claim 21, further comprising:
selecting a review option to review the recorded video.

27. The method of claim 21, wherein said speaking into the camera is at least in part based upon speaking one or more words displayed in a teleprompt script.

28. The method of claim 21, further comprising:
selecting a photo option to capture a still photo with the camera.

29. The method of claim 21, wherein a plurality of videos are recorded and one of the recorded videos is selected for retention in a user portfolio.

30. The method of claim 21, further comprising:
selecting the recorded video for retention in a user portfolio.

31. The method of claim 29 or 30, wherein the selected video is transmitted over a network from the video kiosk to the user portfolio stored on a central database.

32. The method of claim 21, wherein the recorded video is a video resume.

33. The method of claim 21, wherein the recorded video is a video interview, said video interview including responses to one or more questions presented to a person at the video kiosk location.

34. A system comprising:
a video kiosk having a storage unit that houses a video camera coupled to a computer, said computer including a central processing unit, a display, an input means, and a connection to a network; and
wherein said video kiosk is operative to record a video of a user and transmit the recorded video over the network to a video collection server so the recorded video can be associated with a corresponding portfolio in a database containing a plurality of portfolios.

35. The system of claim 34, wherein the user is a candidate seeking a job.

36. The system of claim 34, wherein the user is an employer and the recorded video includes content selected from the group consisting of: a job description, a description of ideal qualifications, a company profile, and interview questions.
